(19) United States
(12) Patent Application Publication
(10) Pub. No.: US 2018/0217404 A1
(43) Pub. Date: Aug. 2, 2018

(54) DECORATIVE ELEMENT FOR THE FRONTAL COVERING OF SPECTACLE FRAMES, AND SPECTACLES INCLUDING SAID DECORATIVE ELEMENT

(71) Applicant: SAFILO SOCIETÀ AZIONARIA FABBRICA ITALIANA LAVORAZIONE OCCHIALI S.P.A., Padova (IT)

(72) Inventors: Nicola BELLI, Padova (IT); Filippo BROCCARDO, Padova (IT)

(73) Assignee: SAFILO SOCIETÀ AZIONARIA FABBRICA ITALIANA LAVORAZIONE OCCHIALI S.P.A., Padova (IT)

(21) Appl. No.: 15/747,534

(22) PCT Filed: Jul. 22, 2016
(86) PCT No.: PCT/IB2016/054391

§ 371 Date: Jan. 25, 2018

(30) Foreign Application Priority Data
Jul. 30, 2015 (IT) 102015000040389

(51) Int. Cl. G02C 11/02

(52) U.S. Cl. CPC G02C 11/02

(57) ABSTRACT

A decorative element is described for covering a frontal lens-holding main member (2a) of a frame (2) of a pair of spectacles (3), said element including a second member (8) devoid of lenses, connectable frontally and removably, as well as in superposition with the main member (2a), so that only said decorative element is intended to remain externally visible from the front when the spectacles are worn, essentially concealing from view the main frontal member (2a) of the spectacle frame (2), means being provided on said second member (8) of the decorative element for the removable holding of the same on the main member (2a) of the spectacle frame. Said means comprise a groove (11) extending without interruption, with a closed-contour profile of development, along the peripheral edge (12) of said second member (8), which is intended to be engaged by the corresponding peripheral contour profile of the main member (2a) in order to couple said members (2a, 8) together.

### TECHNICAL SCOPE

The present invention relates to a decorative element for the frontal covering of spectacle frames, having the characteristics set out in the preamble of main claim 1. The invention also relates to spectacles including the above-mentioned decorative element.

### TECHNOLOGICAL BACKGROUND

The invention falls within the specific technical field of spectacles capable of being frontally coupled with a decorative element, formed as a frontal member devoid of lenses and designed to be interchangeable with other frontal members on the same spectacle frame. Typically, it is envisaged that only the decorative element is intended to remain externally visible from the front when the spectacles are worn, essentially concealing from view the main frontal member of the spectacle frame.

This type of decorative frontal element is designed to allow the easy and rapid creation of spectacles with frontal frames of different shapes and/or colours, choosing from a range of interchangeable decorative frontal elements of different shapes and colours.

Solutions for decorative elements of the indicated type are known in which the means for coupling the decorative frontal element to the spectacle frame provide appendages for localised coupling of the decorative frontal element on to the main member of the spectacles. However, these are not particularly effective for ensuring stability in the reciprocal grip between the coupled parts, which means that they are not particularly practical or convenient in the operations of assembly and disassembly of the decorative member on the main frontal member of the spectacle frame.

### DESCRIPTION OF THE INVENTION

The main aim of the invention is to provide a decorative element for covering the main member of a spectacle frame of the above-mentioned type that is structurally and functionally designed to overcome the limitations mentioned with reference to the cited prior art, and that is therefore easy to manufacture, simplified from a constructional point of view, and at the same time ensures relative rapidity and ease of use while ensuring adequate stability between the coupled parts as well as achieving an appreciable aesthetic impact.

This and other aims that will become clear below are achieved by the invention by means of a decorative element for covering spectacle frames that is created according to the appended claims.

### BRIEF DESCRIPTION OF THE DRAWINGS

The features and advantages of the invention will become clearer from the detailed description that follows of a number of preferred embodiments thereof, given by way of non-limitative example, with reference to the accompanying drawings, in which:

FIG. 1 is a side elevation view of a first embodiment of a decorative frontal element according to the invention, associated in the unassembled condition with a pair of spectacles,

FIG. 2 is a perspective view of the decorative frontal element of FIG. 1,

FIGS. 3 to 5 are respectively front and rear elevation and top plan views of the frontal element of the preceding figures,

FIG. 6 is an enlarged front elevation view of a detail of FIG. 3,

FIG. 7 is a sectional view along the line VII-VII of FIG. 6,

FIG. 7A is a view corresponding to that of FIG. 7, showing partially the coupling of the decorative frontal element to the spectacles,

FIG. 7B is a view corresponding to that of FIG. 7A in a constructional variant of the spectacle frame,

FIG. 7C is a view corresponding to that of FIG. 7A in a further constructional variant of the spectacle frame,

FIG. 8 is a sectional view along the line VIII-VIII of FIG. 3,

FIG. 9 is a rear elevation view of the decorative frontal element of the previous figures coupled to the spectacles,

FIG. 10 is a perspective view of a second embodiment of a decorative frontal element according to the invention,

FIGS. 11 to 13 are respectively front and rear elevation and top plan views of the decorative element of FIG. 10,

FIG. 14 is an enlarged front elevation view of a detail of FIG. 11,

FIG. 15 is a sectional view along the line XV-XV of FIG. 14,

FIG. 16 is a sectional view along the line XVI-XVI of FIG. 11.

### PREFERRED EMBODIMENTS OF THE INVENTION

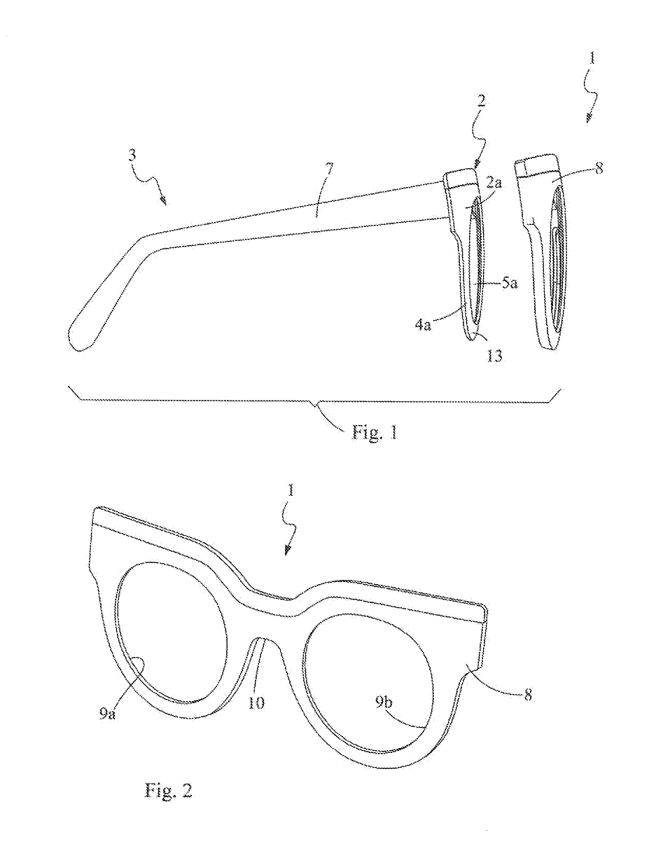

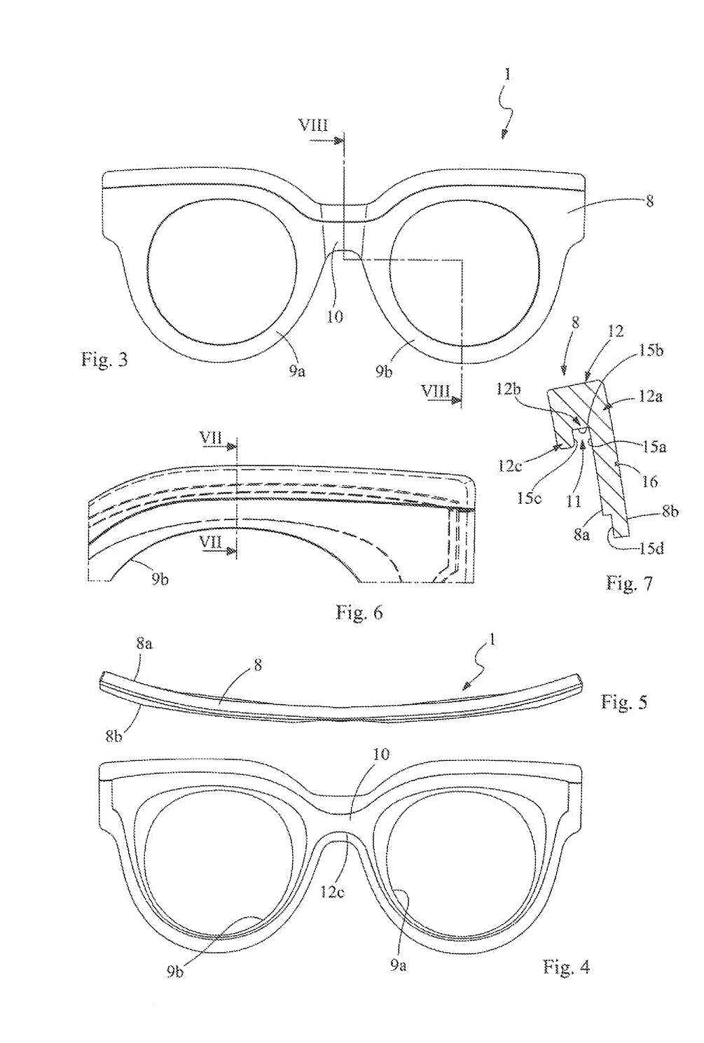

With initial reference to FIGS. 1 to 9, the numeral 1 indicates overall a first embodiment of a decorative element according to the invention, for the frontal covering of a frame 2 of a pair of spectacles 3.

The element 1 is designed to be coupled frontally and removably and in superposition with the frame 2, in such a way that only said decorative element is intended to remain visible externally from the front when the spectacles are worn, essentially concealing from view the corresponding frontal member of the frame.

In the description that follows, the term “inner” is intended to distinguish the side or face of the parts of the spectacle frame 2 and of the decorative element 1 that face towards the user's face with the spectacles fitted on the head, while the term “outer” will be used to refer to the side opposite to the inner side of the corresponding members of the frame and of the decorative element.

The spectacles 3 to which the decorative element 1 can be coupled are of a conventional type and comprise a main frontal member 2a, carrying a pair of lens-holding rims 4a, 4b for holding respective lenses 5a, 5b, said rims being connected by a central bridge 6 in the area of nasal support. Side arms 7 are provided, which are articulated by means of hinges at the opposite lateral ends of the main member 2a.

The decorative element 1 comprises an auxiliary member 8, formed as a frontal frame member, including corresponding rims 9a, 9b, devoid of lenses, connected to each other by a central bridge 10 in the area of nasal support.

In the member 8 are identified an inner face 8a and an outer face 8b, between which the transverse thickness of said member is delimited, means being provided on the inner face 8a for the removable holding of the auxiliary frame 8 on the main frontal member 2a of the frame.

Said means comprise a groove 11, in the form of a channel, extending without interruption, with a closed-contour profile of development, along the peripheral edge 12 of the frontal member 8, which is intended to receive in coupling engagement the corresponding peripheral edge 13 of the main member 2a, in order to couple together said frontal members 2a and 8, with the inner face of the member 8 essentially superposed over the outer face of the main member 2a.

The groove 11 is provided on the inner face 8a of the member 8 and extends to predominantly surround the peripheral profile of the rims 9a, 9b, linking, without any interruption, with portions 11a, 11b of the groove extending in correspondence with the area of the central bridge 10.

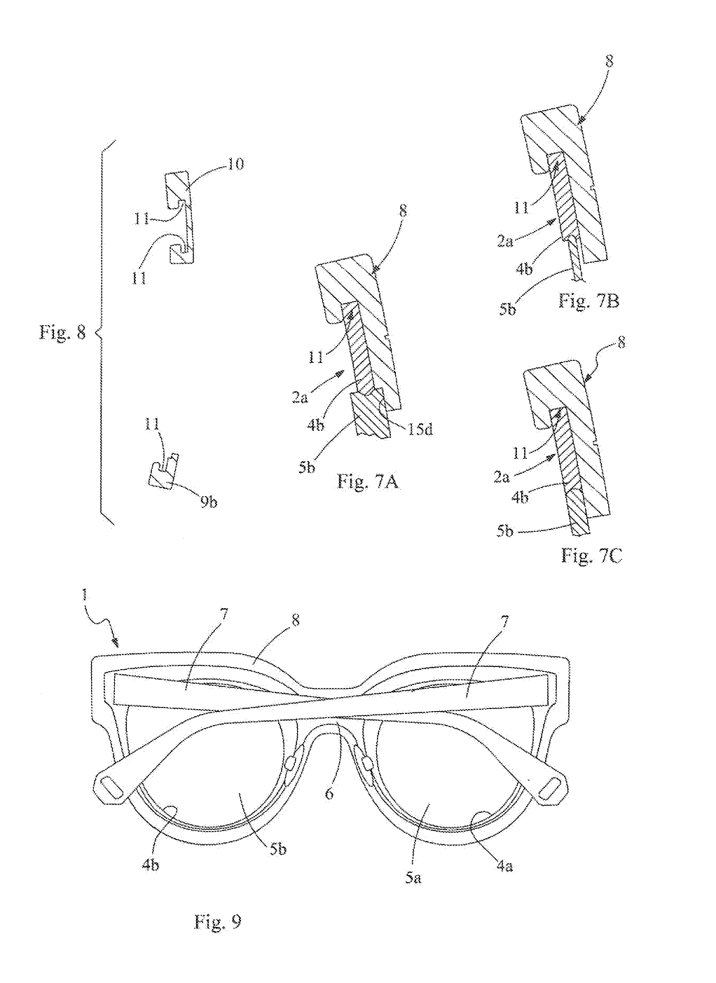

The profile of the peripheral edge 13 of the frontal member 2a is also capable of engaging with the groove 11 with an essential mating of form, as clearly shown in FIG. 7A.

In greater detail, the groove 11 is delimited jointly by a first portion 12a of outer edge 12, by a second portion 12b protruding in relief from the portion 12a, and by a third lip portion 12c of the member 8, the latter developing continuously along the peripheral profile of the groove and extending in prolongation of the second portion 12b.

In the described configuration, the portions 12a, 12c define respective opposite inner surfaces 15a, 15c of the groove, between which is comprised a groove bottom surface 15b defined by the portion 12b.

Thanks to this configuration, the insertion of the corresponding edge portions 13 of the main member 2a into the groove 11 takes place in directions essentially parallel to the inner face of the frontal member 8. The latter is also capable of deforming in an elastically pliable manner in order to allow the peripheral edge 13 of the main member 2a to be housed inside the groove.

Conveniently, it can be provided that the transverse dimension of the groove 11, measured between the opposing surfaces 15a, 15c, has a chosen value smaller than the transverse thickness of the peripheral edge 13 of the main member 2a, so that the coupling of the same in the groove 11 induces a pressure (due to the elastic return generated by the deformation of the groove) on the reciprocal contacting surfaces of the groove (15a, 15c) and of the corresponding portions of the main member 2a opposite to said surfaces, said pressure being suitable to improve the stable holding between the coupled members.

The label 15d denotes a superficial recess in the transverse thickness of the frontal member 8, which is provided to compensate for the difference in thickness between the main frontal member 2a and each of the corresponding lenses 5a, 5b held on the same.

FIG. 7B shows a coupling between the frames 2a and 8 in a constructional variant of the spectacle frame 2, wherein the lenses 5a, 5b have a transverse thickness less than the thickness of the main member 2a. In this case, no superficial recess is provided in the thickness of the frontal member 8.

FIG. 7C shows a coupling between the frames 2a and 8 in a further constructional variant of the spectacle frame 2, wherein the lenses 5a, 5b have a transverse thickness essentially equal to the thickness of the main member 2a. In this case too, no superficial recess is provided in the thickness of the frontal member 8, there being no protrusion of the lenses with respect to said main member.

The frontal member 8 is intended to be made of an elastically pliable plastic material with greater flexibility characteristics than those of the material of which the main member 2a is made, always with the aim of facilitating the removable coupling of the decorative frontal member to the frame of the spectacles 3.

To this end, for creating the member 8, materials belonging to the category known as elastomers can be advantageously used, i.e. plastic materials capable of undergoing substantial deformations under the effect of stresses that need not necessarily be high, without resulting in breakage or permanent deformation of the product, and moreover capable of returning to the original shape and dimension of the product once the stress has been removed. Elastomers are frequently also referred to as ‘rubbers’.

Elastomers combine a high degree of elastic deformability with generally low superficial hardness values, which in practice correspond to a greater softness compared with non-elastomer materials, with degrees of hardness that vary according to the specific formulation of the material. In practice, the superficial hardness value of an elastomer material is frequently used as an index of the degree of flexibility of that material, instead of the value of the elastic modulus measured in traction or of the elastic modulus measured in flexion.

In particular, it is especially convenient to use thermoplastic elastomers (also referred to as TPEs), i.e. elastomers that can be transformed into products by means of the injection moulding process.

The injection moulding process has the advantage of allowing the easy production of parts with forms that are complex and/or critical to their intended function, with a high degree of precision and speed of execution.

In this case, the parts that are most complex and therefore require the greatest precision or have the lowest dimensional tolerances are the peripheral profiles of the rims 9a, 9b of the decorative frontal member 8, in correspondence with the sections that form the groove 11 for coupling with the main member 2a.

The category of thermoplastic elastomers includes, for example, SEBS (styrene-ethylene-butene-styrene) polymer-based materials, as well as polyurethane-based materials (TPUs, thermoplastic polyurethane), both of which in particular, but not exclusively, can be advantageously used for the creation of the decorative frontal member. These are materials that can be easily coloured and are generally characterised by good properties of durability and strength.

The degree of superficial hardness or elasticity of the material is chosen on the basis of obvious technical considerations, such as for example the degree of elastic strength and ease of fitting that is desired to be given to the decorative elastic frontal member, related to the thickness or the cross-sections of the deformable peripheral profiles that contain the groove.

Another type of material that could be used for creating the decorative frontal member is the family of silicone elastomers. These are materials that can typically be transformed by a process of casting in a suitable mould, within which the reticulation of the polymer takes place, i.e. the formation of additional chemical bonds between various molecules of the polymer.

A further advantage offered by the injection moulding process is the possibility of creating products that are made up of different materials, but using a process that is simple, rapid and economical.

Different variants of the injection moulding process are known, referred to respectively as bi-injection, co-injection, super-injection and others, all capable of producing products made up of two or more different plastic materials, and generally described as multi-injection processes.

As regards the decorative frontal member 8 that forms the subject of the present patent application, the general technique of multi-injection can be advantageously used to obtain one or more constructional variants consisting of decorative frontal frames made up of different materials, in correspondence with different parts or areas of said frontal frames, with the aim of exploiting the different aesthetic or functional characteristics of the various materials from one area to the next.

For example, it is possible to obtain a main part of the member, and in particular the part made up of said rims 9a, 9b and the connecting bridge 10 between them, using a given plastic material, and to obtain the peripheral profiles, which form the continuous sections of the groove 11, using a second, different plastic material.

Still with reference to the described embodiment, it is possible to create the rims and the bridge using a material that is less soft and elastic, or even not particularly soft and elastic (for example a material belonging to the polyamides family), in order to give the main structure of the frontal frame 8 certain characteristics that cannot be obtained with elastomers or rubbers. These possible characteristics include but are not limited to: any types of decorations, finishes or colourings which, in order to be capable of being applied, require the exposure of the material to high temperatures at which the common elastomers would suffer damage or degradation (for example, decoration by sublimation printing). They also include decoration, finishing or colouring processes which, in order to ensure good treatment performance and durability, require good chemical compatibility between the decorated material and the “coating” (i.e. the ink, pigment or paint) used in the decoration process, and for which the known and available elastomers are not suitable because they are not chemically compatible with said coating (ink, pigment or paint). Alternatively, it may simply be desired to limit the characteristics of softness and high elastic deformability to the portions intended for the mounting of the decorative frontal member on to the main member, considering that this will allow the main structure of the decorative frontal member to provide a different tactile sensation with respect to the sensations typically suggested by the elastomers—for example, to allow the perception of a higher value of the material or product with respect to the modest value generally perceived with the elastomers.

In this case, it can be opted to create the main structure by using a plastic material characterised by a higher superficial hardness and/or by a greater rigidity or a higher elastic modulus, and therefore a material that is not per se technically ideal for the creation of the parts intended for attachment to the main frontal member but is capable of conveying a sensation of greater strength, or is simply considered to be more pleasant to the touch.

To this end, a process of bi-injection or super-injection can be advantageously used, firstly injecting the main part of the decorative frontal member using the harder and more rigid plastic material, and then injecting on to this the part or parts made of a softer and more flexible material.

The two different materials will obviously be chosen from types of materials that are chemically compatible with each other and are therefore capable of adhering to each other.

A further advantage in using a multi-injection technique for creating the decorative frontal member 8 can be offered by the possibility of creating, for example, said main structure of the decorative member in multiple portions, possibly created with the same type of material, but characterised by different colours or chromatic effects, in this case for purely aesthetic purposes.

The numeral 16 also indicates an indentation, in the form of a groove of narrow width, which is formed on the outer face of the member 8, extending between the opposite lateral ends of the same, with a line of running development in correspondence with the areas of the eyebrow arches. The outer face of the member 8 is divided by the indentation 16 into two distinct areas that can more easily be subjected to a different coloration, in order to improve the aesthetic qualities of the decorative element.

With reference to FIG. 9, it is clear that the decorative frontal member has a peripheral profile that protrudes frontally beyond the corresponding profile of the main member 2a, as well as in correspondence with the inner profile of the rims, such a configuration allowing the decorative member to cover entirely and conceal from view the main member of the spectacle frame when the eyes are viewed from the front side.

It follows from this that the decorative frontal member 8 can substantially modify the style of the main frontal member 2a of the spectacle frame, both in terms of shape and/or of coloration. Moreover, the decorative member 8 is interchangeable with other decorative frames of different style and/or coloration, in order to increase the possible different configurations that can be associated with the main member of the spectacle frame.

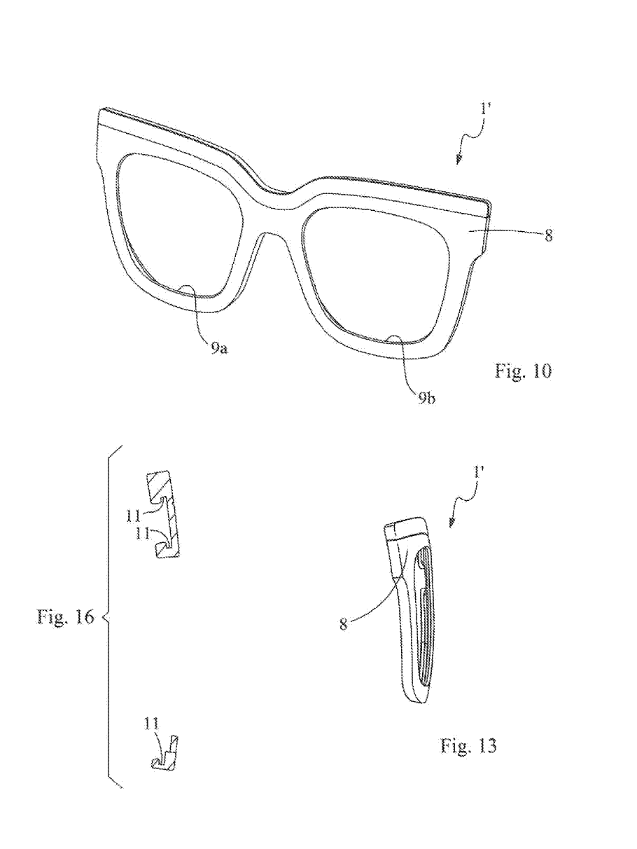

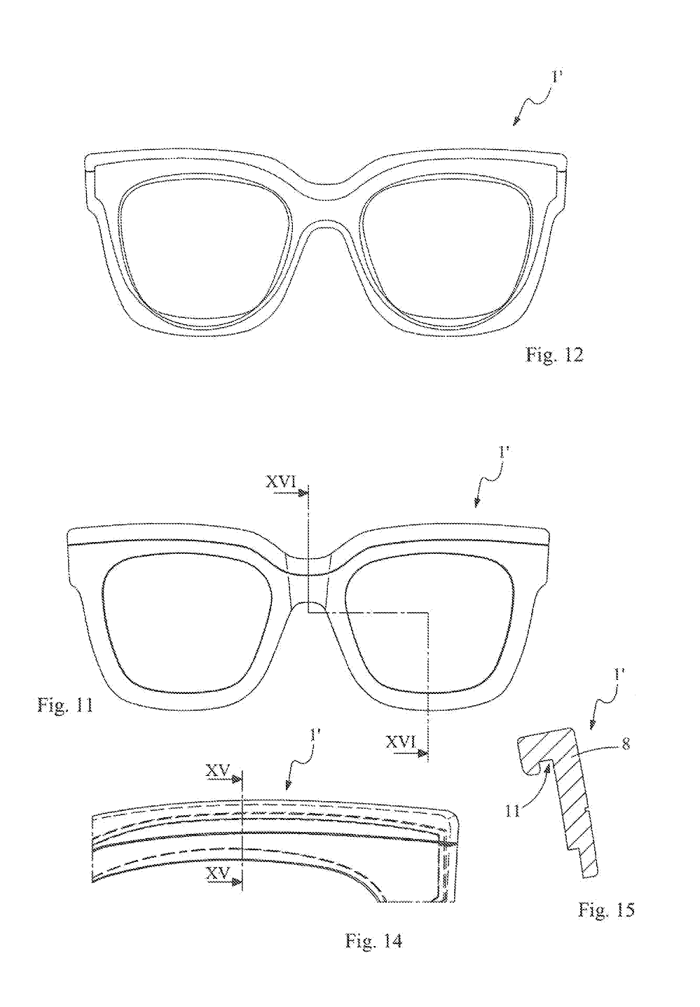

FIGS. 10 to 16 relate to a second embodiment of a decorative frontal member, globally indicated by the numeral 1′, in which details similar to those of the first described embodiment are denoted by the same numeric references. This second embodiment is designed, with respect to the previous one, with a different shape of the profiles that frontally delimit the rims and the central connecting area of the same, as can be clearly seen in the corresponding figures. From the functional point of view, the frontal member of this embodiment is entirely similar to the first described embodiment.

The invention thus achieves the proposed aims, providing the stated advantages with respect to the known solutions.

In particular, it offers improved rapidity and convenience of use in the fitting/removal of the decorative frontal element, while ensuring adequate stability between the coupled parts as well as achieving an appreciable aesthetic impact.

A further advantage is that of being able to associate with the spectacle frame not only a decorative frontal element but a series of interchangeable frontal elements, with different forms in terms of the external shape and the shape of the pair of eyepieces (openings in the rims), so that by switching the decorative frontal elements on the spectacle frame one obtains the effect of changing the design of the spectacles, including the “silhouette” of the lens. Advantageously it is also possible to provide a range of different colours for a given decorative frontal element or for frontal elements of different shapes.

It should be noted that, although the described examples of the invention relate to a decorative frontal member accompanied by closed rims, it is understood that the invention is also equally applicable to decorative elements that include frontal members with partially open rims, in which case the interchangeable coupling of the decorative frontal element with the corresponding main frontal member of the spectacle frame is effected in a suitable manner.

1. Decorative covering element for a main frontal lens-holding member (2a) of a frame (2) of a pair of spectacles (3), said element including a second member (8) devoid of lenses, connectable frontally and removably, as well as in superposition with the main member (2a), so that only said decorative element is intended to remain externally visible from the front when the spectacles are worn, essentially concealing from view the main frontal member (2a) of the spectacle frame, means being provided on said second member (8) of the element for the removable holding of the same on the main member (2a) of the spectacle frame, wherein said means comprise a groove (11) extending without interruption, with a closed-contour profile of development, along a peripheral edge (12) of said second member (8), which is engagable with a corresponding peripheral contour profile of the main member (2a) in order to couple said main and second members (2a, 8) together.

2. The decorative element according to claim 1, wherein said second member (8) of the decorative element is capable of deforming in an elastically pliable manner in order to allow a peripheral edge (13) of the main member (2a) to be received inside said groove (11).

3. The decorative element according to claim 1 wherein said second member (8) comprises a pair of rims (9a, 9b) devoid of lenses connected by a bridge (10) extending in correspondence with a central area of nasal support, said groove (11) extending to predominantly surround a peripheral profile of said rims (9a, 9b), linking without interruption to sections of said groove (11) extending in correspondence with said central connecting bridge (10) of the rims.

4. The decorative element according to claim 2, wherein the profile of the peripheral edge (13) of the main member (2a) is capable of engaging said groove (11) with an essential form fit.

5. The decorative element according to claim 4, wherein said groove (11) is defined jointly by a first portion (12a) of outer edge (12) of said second member (8), by a second portion (12b) protruding in relief from said first portion (12a), and by a third lip portion (12c) of said second member (8) running along a peripheral profile of said second portion.

6. The decorative element according to claim 5, wherein said first edge portion (12a) of the second member (8) and said third lip portion (12c) define respective opposite inner surfaces (15a, 15c) of said groove (11), between which is comprised a groove bottom surface (15b) defined by said second portion (12b).

7. The decorative element according to claim 6, wherein a transverse dimension of the groove (11), measured between said opposing surfaces (15a, 15c), is less than a transverse thickness of the peripheral edge profile (13) of the main member (2a), so that coupling of the main member (2a) in the groove (11) induces a pressure on the reciprocally contacting surfaces (15a, 15c) of the groove (11) and of the corresponding portions of the main member (2a) superposed thereon.

8. The decorative element according to claim 1, wherein the decorative element is made of a plastic material with elastic pliability characteristics greater than those of a material from which the main member (2a) is made.

9. The decorative element according to claim 1, wherein said second member (8) is made of a plastic material which is an elastomer.

10. The decorative element according to claim 1, wherein said second member (8) is obtained by injection molding.

11. The decorative element according to claim 10, wherein said second member (8) is obtained by a multi-injection technique in order to create respective portions of the second member in corresponding materials and/or different colors.

12. Spectacles comprising a frame (2) with a main frontal member (2a) provided with lens-holding rims (4a, 4b) for holding respective lenses and a decorative element according to claim 1, said element including an auxiliary member (8) devoid of lenses, connectable frontally and removably to the main member (2a).
